(19) United States
(12) Patent Application Publication
(10) Pub. No.: US 2026/0044116 A1
(43) Pub. Date: Feb. 12, 2026

(54) LASER SUBTRACTIVE MANUFACTURING OF AN OVERSIZED MIM BLANK

(71) Applicant: Fossil Group, Inc., Richardson, TX (US)

(72) Inventors: Brad D. Brinson, San Francisco, CA (US); Sean E. Daley, San Jose, CA (US); Simon Wu, New Taipei City (TW); Min Li Tee, Singapore (SG); Wai Yuen Law, Port Coquitlam (CA)

(21) Appl. No.: 19/360,738

(22) Filed: Oct. 16, 2025

Related U.S. Application Data
(62) Division of application No. 17/410,678, filed on Aug. 24, 2021, now abandoned.

(51) Int. Cl. G04D 3/00; B23K 26/00; B23K 26/361; G04B 37/22; G04G 17/00

(52) U.S. Cl. CPC G04D 3/0069; B23K 26/0093; B23K 26/361; G04B 37/22; G04G 17/00

(57) ABSTRACT

Types of metal component parts including a casing, a bezel, a buckle, parts for a watch band, etc. are made with the Metal Injection Molding (MIM) process. Each type of metal component part can be derived from an instance of a MIM blank corresponding to that particular type of metal component part formed from its corresponding injection molding tool. The MIM blank formed for the metal component part from the injection molding tool then has a portion of the MIM blank subtracted through a laser subtraction process to form an interim shape and geometry of the instance of the metal component part. The laser subtraction process is applied to the instance of the MIM blank for the metal component part when the instance of the MIM blank has not yet been sintered and hardened to a finished shape and geometry for that metal component part for the watch design.

### RELATED APPLICATIONS

This application claims the benefit of priority under 35 USC 120 as a divisional patent application from U.S. patent application Ser. No. 17/410,678, filed Aug. 24, 2021, titled “LASER SUBTRACTIVE MANUFACTURING OF AN OVERSIZED MIM BLANK,” where the entire contents of which are hereby incorporated by reference for all purposes.

### FIELD

The design generally relates to wearable timekeeping devices, such as a watch.

### BACKGROUND

Traditionally, watches can create their metal component parts in different ways. One prior art technique starts off with a hardened billet of steel and then form the metal part via stamping and machining that hardened billet into a final watch component part. Laser cutting was just a few years ago was a very expensive process and not very developed. Also, traditionally, most MIM parts are formed as the specific final shape and dimensions, and thus, do not require much post process cutting or material removal from any MIM blank coming out of the injection molding.

### SUMMARY

In general, a wearable time keeping device is discussed. In an embodiment, a method of making metal component parts for a watch with a Metal Injection Molding (MIM) process is discussed. One or more of types of metal component parts such as i) a casing, ii) a bezel, iii) a buckle, iv) parts for a watch band, and v) any combination of these, with the Metal Injection Molding (MIM) process. Each type of metal component part for a watch design can be derived from an instance of a MIM blank corresponding to that particular type of metal component part formed from its corresponding injection molding tool. The instance of the MIM blank formed for the metal component part from the injection molding tool then has at least a portion of the instance of the MIM blank subtracted through a laser subtraction process to form an interim shape and geometry of the instance of the metal component part for the watch design. The laser subtraction process is applied to the instance of the MIM blank for the metal component part when the instance of the MIM blank has not yet been sintered and hardened to a finished shape and geometry of the final instance of the type of metal component part for the watch design.

Likewise an embodiment of a MIM production line for making a metal component part for a wearable time keeping device is discussed. A same injection molding tool makes instances of a MIM blank for that particular type of metal component part. The metal component part can include i) a casing, ii) a bezel, iii) a buckle, iv) parts for a watch band, and v) any combination of these. One or more sub process stations at least including a laser station. An instance of the metal component part corresponding to one of the types of metal component parts is made from an instance of the MIM blank for that metal component part formed from the injection molding tool. The instance of the MIM blank for that metal component part has had at least a portion of the instance of the MIM blank subtracted through a laser subtraction process at the laser station to form an interim shape and geometry of the metal component part when not in a hardened state. In addition, the instance of the MIM blank for that metal component part then went through a sintering process at a sinter station to then harden the metal component part to a finished shape and geometry of the metal component part. A size and shape of the instance of the MIM blank is formed such that the metal component part is derivable from the instance of the MIM blank using, at least, the sub process of the laser process, to achieve two different finished shapes and geometries of the metal component part in accordance with specifications of two or more different wearable time keeping device designs. The finished geometry and shape of a first instance of the metal component part for a first wearable time keeping device design differs from a finished shape and geometry of a second instance of the metal component part for a second wearable time keeping device design even though these metal component parts come from instances of identical MIM blanks formed from the same injection molding tool.

These and other designs are discussed.

### BRIEF DESCRIPTION OF THE DRAWINGS

The multiple drawings refer to the example embodiments of the design.

FIGS. 1A-1D illustrate a flow diagram of an embodiment of an example Metal Injection Molding (MIM) process including a laser subtraction process, with at least the inclusion of one or more sub processes, to make metal component parts for a watch where instances of example component parts are customized in shape and geometry of the component part while not in its hardened shape (e.g. a green state) to achieve an interim shape and geometry of that instance of the component part.

FIG. 2 illustrates a flow diagram of an embodiment of an example MIM process with a laser subtraction process and/or a CNC milling sub process to make metal component parts for a watch where instances of example metal component parts are customized in finished geometry and shape for different watch designs.

FIG. 3 illustrates a diagram of an embodiment of an example overlay of an instance of the MIM blank in a green state and not hardened from the injection molding tool that is big enough to be customized to form many different finished aesthetics, shapes, and/or geometries, via at least a laser subtraction process and/or a CNC machining process of that MIM blank, in accordance with different watch designs.

FIG. 4 illustrates a side by side comparison diagram of an embodiment an instance of an example MIM blank from the injection molding tool as well as an example interim shape and geometry of that instance of the metal component part in its not hardened state after being shaped via at least a laser subtraction process and/or a CNC machining process in accordance with the specification of that watch design.

FIG. 5 illustrates a side by side comparison diagram of an embodiment an instance of an example finished hardened state of the example component part, such as a watch casing, after sintering of the component part as well as the example component part in a final shape, geometry and/or ascetics corresponding to the specific specifications for that instance ID of a given watch design.

FIG. 6 illustrates a diagram of an embodiment of an example interim shape and geometry of that instance of the metal component part in its not hardened state after being shaped via at least a laser subtraction process to make shapes and geometry in small dimensions for a new feature being formed and/or 2) refining an existing feature on the MIM blank from the injection molding tool.

FIG. 7 illustrates a diagram of an embodiment of an example interim shape and geometry of that instance of the metal component part in its not hardened state after being shaped via at least a laser subtraction process, in which the laser can have its focal length adjusted and controlled to make 3 dimensional features in the instance of the MIM blank prior to sintering and hardening to the finished shape and geometry of the instance of the metal component part.

FIG. 8 illustrates a block diagram of an example computing system that may be used in an embodiment of one or more of the servers, wearable time keeping digital devices, and client devices discussed herein.

FIG. 9 illustrates a diagram of a network environment in which the wearable time keeping device and techniques described herein may be applied.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of wearable time keeping devices, named components, connections, number of seals, etc., in order to provide a thorough understanding of the present design. It will be apparent; however, to one skilled in the art that the present design may be practiced without these specific details. In other instances, well known components or methods have not been described in detail but rather in a block diagram in order to avoid unnecessarily obscuring the present design. Further, specific numeric references such as first enclosure, may be made. However, the specific numeric reference should not be interpreted as a literal sequential order but rather interpreted that the first enclosure is different than a second enclosure. Thus, the specific details set forth are merely exemplary. The specific details discussed in one embodiment may be reasonably implemented in another embodiment. The specific details may be varied from and still be contemplated to be within the spirit and scope of the present design.

The following drawing and text describe various example implementations of the design.

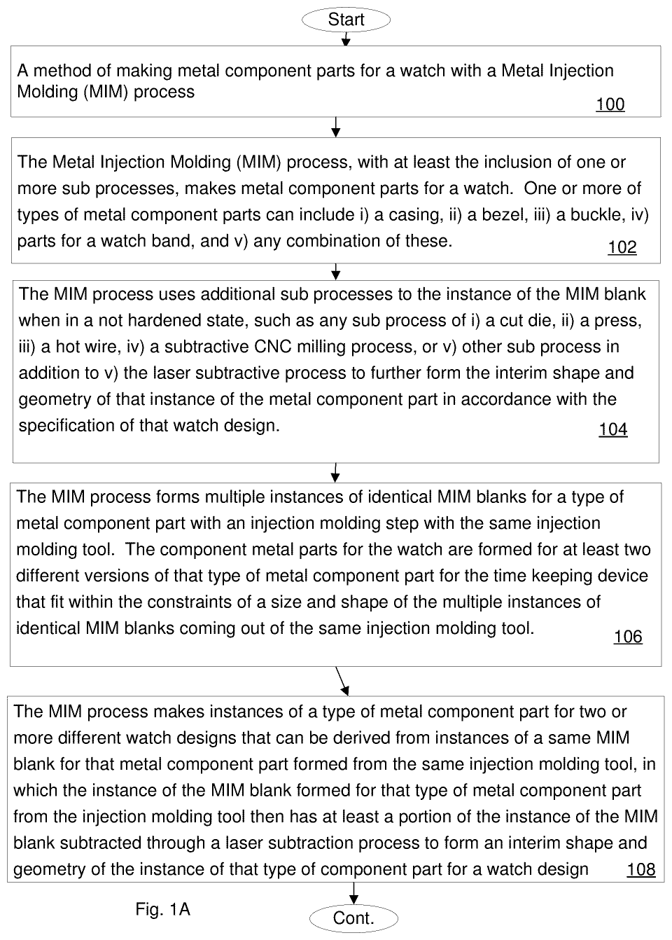

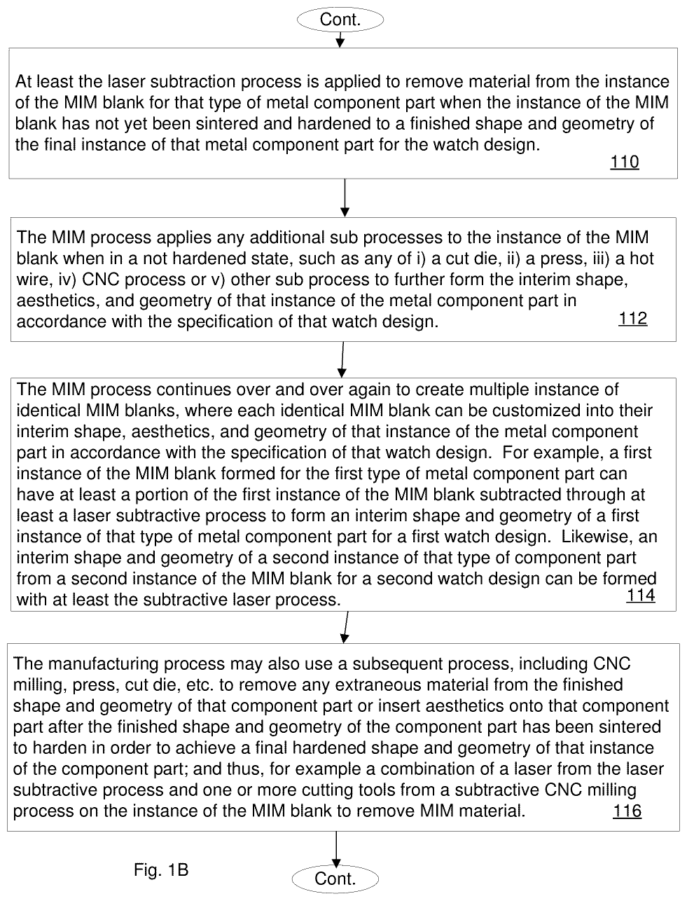

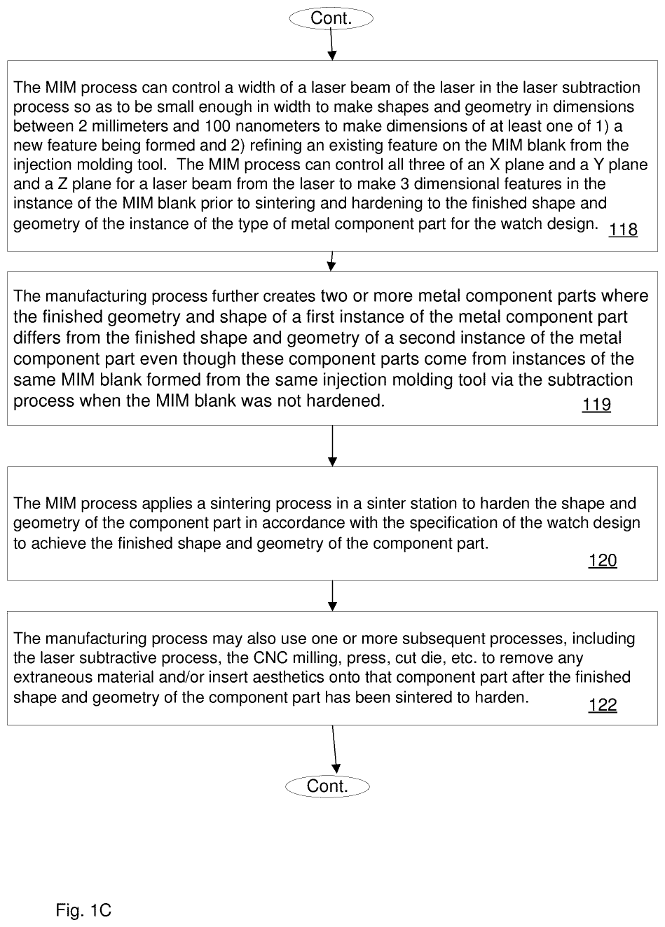

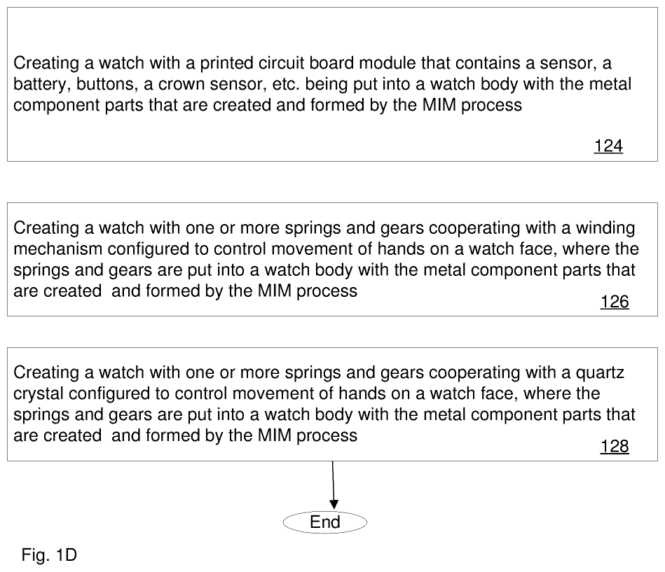

FIGS. 1A-1D illustrate a flow diagram of an embodiment of an example Metal Injection Molding (MIM) process, with at least the inclusion of one or more sub processes including a laser subtraction process, to make metal component parts for a watch where instances of example component parts are customized in shape and geometry of the component part while not in its hardened shape (e.g. a green state) to achieve an interim shape and geometry of that instance of the component part.

In step 100, the MIM process, with at least the inclusion of one or more sub processes, makes metal component parts for a watch.

In step 102, one or more of types of metal component parts can include i) a casing, ii) a bezel, iii) a buckle, iv) parts for a watch band, and v) any combination of these with the Metal Injection Molding (MIM) process.

In step 104, the MIM process uses additional sub processes to instances of the MIM blank when in a not hardened state, such as any sub process of i) a cut die, ii) a press, iii) a hot wire, iv) a subtractive CNC milling process, or v) other sub process in addition to v) the laser subtractive process to further form the interim shape and geometry of that instance of the metal component part in accordance with the specification of that watch design.

In step 106, the MIM process forms multiple instances of identical MIM blanks for a type of metal component part with an injection molding step with the same injection molding tool. The component metal parts for the watch are formed for at least two different versions of that type of metal component part for the time keeping device that fit within the constraints of a size and shape of the multiple instances of identical MIM blanks coming out of the same injection molding tool. The different versions of that type of metal component parts for the time keeping device, such as a watch, are formed via using at least the laser subtraction process to achieve two or more different finished shapes and geometries for that metal component part.

In step 108, the MIM process makes instances of a type of metal component part for two or more different watch designs that can be derived from instances of a same MIM blank for that metal component part formed from the same injection molding tool, in which the instance of the MIM blank formed for that type of metal component part from the injection molding tool then has at least a portion of the instance of the MIM blank subtracted through a laser subtraction process to form an interim shape and geometry of the instance of that type of component part for a watch design.

In step 110, at least the laser subtraction process is applied to remove material from the instance of the MIM blank for that type of metal component part when the instance of the MIM blank has not yet been sintered and hardened to a finished shape and geometry of the final instance of that metal component part for the watch design. The laser subtraction process as well as the subtractive Computer Numerical Control (CNC) milling process on the instance of the MIM blank can remove and/or shape portions of that component in accordance with its watch design.

In step 112, the MIM process applies any additional sub processes to the instances of the MIM blank when in a not hardened state, such as any of i) a cut die, ii) a press, iii) a hot wire, iv) CNC process or v) other sub process to further form the interim shape, aesthetics, and geometry of that instance of the metal component part in accordance with the specification of that watch design.

In step 114, the MIM process continues over and over again to create multiple instance of identical MIM blanks, where each identical MIM blank can be customized into their interim shape, aesthetics, and geometry of that instance of the metal component part in accordance with the specification of that watch design. For example, a first instance of the MIM blank formed for the first type of metal component part can have at least a portion of the first instance of the MIM blank subtracted through at least a laser subtractive process to form an interim shape and geometry of a first instance of that type of metal component part for a first watch design. Likewise, an interim shape and geometry of a second instance of that type of component part from a second instance of the MIM blank for a second watch design can be formed with at least the subtractive laser process. As discussed, in addition a CNC milling process and/or another process discussed here could be used on the MIM blank in it not hardened state (e.g. green state) along with the laser subtractive process. When a CNC milling process is used then each different watch design would use a different CNC sequence for the subtractive CNC milling process according to the watch design specifications. Likewise, a laser subtraction process would use a different sequence for the subtractive laser process according to the watch design specifications to produce two different components from instances of identical MIM blanks. For example, a first casing and a second casing from instances of identical MIM blanks have different finished shapes and geometries after being modified during the laser subtraction process and then sintered and hardened to their finished shape and geometry. Again, the laser subtraction process removes MIM material with a laser in a controlled method to form at least one of functional geometry and decorative geometry on the MIM blank from the injection molding tool.

In step 116, again, the interim shape and geometry of the instance of that type of metal component part for the watch design can be formed by a combination of the laser subtraction process and a subtractive CNC milling process on the instance of the MIM blank to remove MIM material from the MIM blank, prior to sintering and hardening to the finished shape and geometry of the instance of the type of metal component part for the watch design. The finished geometry and shape of the first instance of the first type of component part differs from a finished shape and geometry of the second instance of the first type of component part even though these component parts come from instances of identical MIM blanks formed from the same injection molding tool. This customization of roughly similar component metal parts for different watch design can occur for many, many different watch designs. For example, 500 bezels with a first shape and geometry can be produced and then 250 bezels with a second shape and geometry and then 150 bezels with a third shape and geometry can all be produced from the same production line using the same injection molding tool by merely changing the coding for the laser subtraction process and in this example the coding in the CNC milling process.

Thus, the MIM process can form a first instance of the bezel with the same injection molding tool for a first watch design from a first instance of the MIM blank with the MIM process, and then can create at least a portion of a first interim shape and geometry of the first bezel for the first watch design with the subtractive laser process when the first instance of the MIM blank has not yet been sintered to harden a finished shape and geometry of the first bezel in order to create a first instance of the bezel with a first distinctive shape and geometry. And, the MIM process can form a second instance of the bezel (an identical MIM blank for the bezel) with the same injection molding tool for a second watch design from a second instance of the MIM blank with the MIM process, and then create at least a portion of a second interim shape and geometry of the second bezel for the second watch design with the subtractive laser process when the second instance of the MIM blank has not yet been sintered to harden a finished shape and geometry of the second instance of the bezel in order to create a second instance of the bezel with a second distinctive shape and geometry that is distinctive from the first distinctive shape and geometry.

The MIM process can use both i) a laser from the laser subtractive process in addition to ii) one or more cutting tools from a subtractive CNC milling process to form the interim shape and geometry of the MIM blank when the MIM blank has not yet been sintered. The cutting tools of a CNC station and a laser beam of the laser cooperate to make a series of rough and precise cuts to form a geometric structure on the MIM blank from the injection molding tool. The laser can be used by itself, as well as in conjunction with a CNC station to make a rough cut to get the profile desired and then fine detail can be burned and created through laser reduction of material to get the geometric structures that are forming the actual structure of the product being made manufactured, where multiple instances of a same part for this product are going to be repeatedly manufactured.

In step 118, the MIM process can control a width of a laser beam of the laser in the laser subtraction process so as to be small enough in width to make shapes and geometry in dimensions between 2 millimeters and 100 nanometers to make dimensions of at least one of 1) a new feature being formed and 2) refining an existing feature on the MIM blank from the injection molding tool. The MIM process can control all three of an X plane and a Y plane and a Z plane for a laser beam from the laser to make 3 dimensional features in the instance of the MIM blank prior to sintering and hardening to the finished shape and geometry of the instance of the type of metal component part for the watch design.

In step 119, the manufacturing process further creates two or more metal component parts where both the finished and final geometry and shape of a first instance of the metal component part differs from the finished and final shape and geometry of a second instance of the metal component part even though these component parts come from instances of the same MIM blank formed from the same injection molding tool and various sub process when that instance of the MIM blank was not hardened.

In step 120, the MIM process applies a sintering process in a sinter station to harden the shape and geometry of the component part in accordance with the specification of the watch design to achieve the finished shape and geometry of the component part. Thus, in an example, sintering the shape and geometry of the second instance of the bezel for the second watch design to achieve hardened metal in the finished shape and geometry of the second instance of the bezel for the second watch design. A finished geometry and shape of the second instance of the type of component part in the second watch design differs from the geometry and shape of the first instance of the type of component part in the first watch design. The MIM process may use alternative processes to harden the interim shape, aesthetics, and geometry of that instance of the metal component after the sub processes have formed the interim shape, aesthetics, and geometry of that instance of the metal component.

In step 122, the manufacturing process may also use one or more subsequent processes, including the laser subtractive process, the CNC milling, press, cut die, etc. to remove any extraneous material and/or insert aesthetics onto that component part after the finished shape and geometry of the component part has been sintered to harden. However note, the removal of material and shaping of the component part while in its not hardened shape, prior to step 120, to achieve an interim shape and geometry of that instance of the component part saves a large amount of time, money, and specialization of many other manufacturing steps to achieve the final hardened shape and geometry of that instance of the component part. As in traditional metal component parts in a finished hardened stage, the metal component part may need be to softened from its harden state to a point to remove additional material and/or shape the metal component part and/or insert aesthesis on that metal component part.

Note, the use of the laser with ability to add fine details (e.g. dimensions between 2 millimeters and 100 nanometers via beam width control, power level of the beam, and time the laser is applied to the MIM blank in a non-hardened state, can often reduce and/or eliminate a need to use a subsequent process to remove any extraneous material from the finished shape and geometry of the second bezel for the second watch design after the finished shape and geometry of the second bezel has been sintered to harden in order to achieve a clean version of the final hardened shape and geometry of the second bezel.

In step 124, the manufacturing process further assembles parts to create a digital watch with a printed circuit board module that contains a sensor, a battery, buttons, a crown sensor, etc. being put into a watch body with the metal component parts that are created and formed by the MIM process. one or more of the metal component parts that are created and formed by the MIM process cooperating with the printed circuit board module that contains the sensor, the battery, the buttons, a digital display within the wearable time keeping device.

In step 126, the manufacturing process further creates a watch with a watch face, one or more springs and gears cooperating with a winding mechanism configured to control movement of hands on the watch face, where the springs and gears are put into a watch body with the metal component parts that are created and formed by the MIM process. One or more springs and gears configured to control movement of hands on the watch face, where the springs and gears are put into a watch with the metal component parts that are created and formed by the MIM process.

In step 128, the manufacturing process further creates a watch with a watch face, a battery, one or more springs and gears cooperating with a quartz clock configured to control movement of hands on the watch face, where the springs and gears are put into a watch body with the metal component parts that are created and formed by the MIM process.

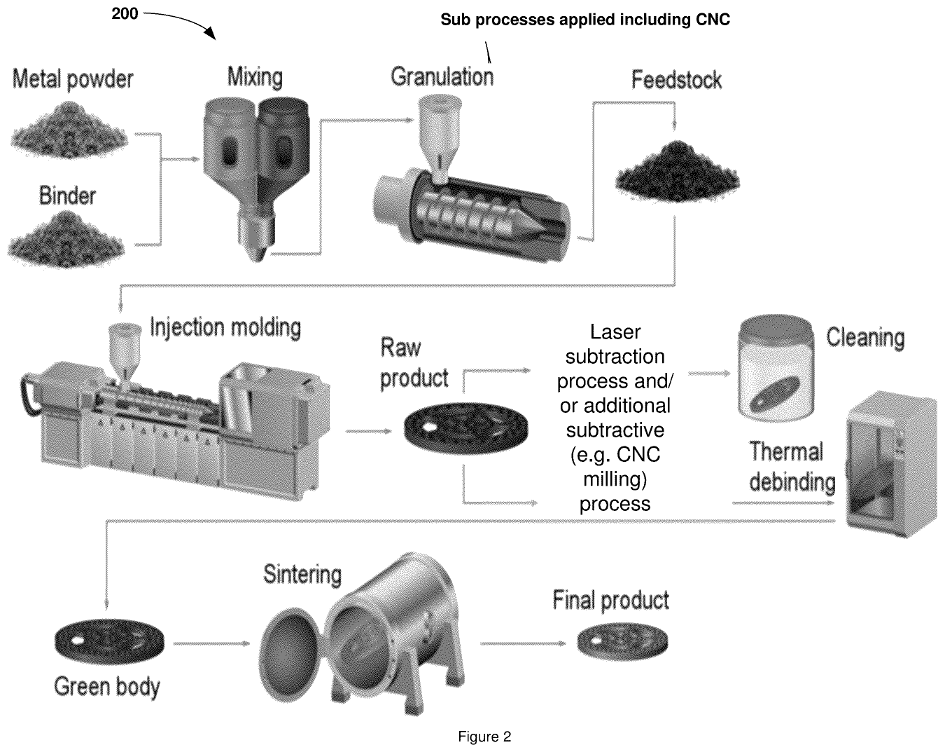

FIG. 2 illustrates a flow diagram of an embodiment of an example MIM process with a laser subtraction process and/or a CNC milling sub process to make metal component parts for a watch where instances of example metal component parts are customized in finished geometry and shape for different watch designs. The MIM process 200 makes metal component parts for a watch with a CNC milling sub process to make metal component parts. The one or more of types of metal component parts can include i) a casing, ii) a bezel, iii) a buckle, iv) parts for a watch band, and v) any combination of these. The MIM process 200 can be a metalworking process that uses finely-powdered metals combined with binder material (e.g. plastic) to create a molten feedstock that can be injected into a mold cavity to form a complex shape. The MIM process 200 is different from prior techniques of mere forging of metal parts or mere metal stamping of a hardened billet of metal.

In this example MIM process 200, metal powder and a polymer binder are mixed in a mixer. These can then go through a granulator. A feedstock is added. An instance of the MIM blank for a component part is formed with this injection molding step with the injection molding tool. The injection molding tool then creates instances of a MIM blank for a component part in a green state. The instance of the MIM blank as a green part is made large enough to later make customizations via the sub processes in accordance with an instance watch design ID. This MIM process 200 at least uses at least a sub process of a laser station, a CNC milling station, etc., to move away from progressive metal stamping, to at least laser subtracted and/or CNC milled parts, which unlocks massive customization of instances of component parts for different watch design IDs from a same injection molding tool. where an instance of the metal component part corresponding to one of the types of metal component parts is made from an instance of the MIM blank for that metal component part formed from the injection molding tool, where the instance of the MIM blank for that metal component part has had at least a portion of the instance of the MIM blank subtracted through a laser subtraction process at the laser station to form an interim shape and geometry of the metal component part when not in a hardened state, and then the instance of the MIM blank for that metal component part went through a sintering process at a sinter station to then harden the metal component part to a finished shape and geometry of the metal component part. The metal component part is made from the instance of the MIM blank for that component part formed from the injection molding tool. Another sub process tool station using i) a cut die, a press, etc. can be used to form and customize the interim shape and geometry of the first instance of the metal component part in addition to ii) the laser subtraction and/or the CNC milling station to further form the interim shape and geometry of the first instance of the metal component part when the first instance of the metal component part has not yet been sintered. The laser subtraction and a CNC milling from the CNC milling station are applied to remove MIM material from a first instance of the MIM blank for a first type of component part when a first instance of the MIM blank has not yet been sintered and hardened to a finished shape and geometry of the first instance of the first type of metal component part for the first wearable time keeping device design. The laser station includes a laser which can be adjusted and controlled in all three of an X plane and a Y plane and a Z plane for a laser beam from the laser to make 3 dimensional features in the instance of the MIM blank prior to sintering and hardening to the finished shape and geometry of the instance of the type of metal component part for the watch design.

The laser station includes a laser which can have its focal length adjusted and controlled to make 3 dimensional features in the instance of the MIM blank prior to sintering and hardening to the finished shape and geometry of the instance of the type of metal component part for the watch design. Note, for speed generally a laser with a capability of changing its focal distance and the height distance when making these cuts will be used so that the part informing the geometric structures will continuously be created. For the first instance of the part being manufactured followed by the second instance and the thousand this is instance that day of that part being manufactured and produced.

The MIM process can also control a width of a laser beam of the laser in the laser subtraction process so as to be small enough in width to make shapes and geometry in dimensions between 2 millimeters and 100 nanometers to make dimensions of at least one of 1) a new feature being formed and 2) refining an existing feature on the MIM blank from the injection molding tool.

The instance of a customized metal component part in a green state can go through solvent debinding and/or thermal debinding to become an instance of a component part in a brown state. The instance of a component part in a green body state goes through a sintering process to harden the component part to a finished state. Multiple sub processes can be applied to form the interim shape, geometry, and/or aesthetics of that component part, such as a green part or brown part. The laser subtraction and/or CNC subtraction process can be applied to each instance of a MIM blank in a green state, brown state, /not hardened component part, to at least subtract a portion of the MIM blank through CNC machining to achieve a specific aesthetic, shape, and geometry of that component part to conform to a finished shape and geometry of that part in a given watch ID design.

A size and shape of the instance of the MIM blank is formed such that the metal component part is derivable from the instance of the MIM blank using at least, the sub process of the CNC milling process, to achieve at least two or more different finished shapes and geometries of the component part in accordance with specifications of two or more different watch designs. Thus, multiple different finished shapes and geometries of bezels may come from a same instance of a MIM blank of that component. Thus, multiple different finished shapes and geometries of casings may come from a same instance of a MIM blank of that component. Similar examples of iii) a buckle, iv) parts for a watch band, go on, etc. etc.

The customization of the MIM blank allows for a common set of the internal mechanical features the i) PCBA module, ii) battery, and/or iii) other internal parts of a watch to interface with the metal component parts. This allows for the repeatability of the internal mechanical features while customization of the metal component parts. For example, a laser subtraction of material from a MIM Blank allows flexibility with creating a new external geometry but keep the internal detail mechanical interface details the same.

A same manufacturing production line for making a type of metal component part can be used to make many, many different instances with different geometries, aesthetics, and shapes for different watch designs. At least the subtractive laser process is applied to an instance of the MIM blank for the type of component part to customize that instance of the same MIM blank when it is in its interim shape and geometry and has not yet been sintered and hardened to a finished shape and geometry of that component part. For example, a first watch design has a customized shape and geometry with its metal parts compared to a second watch design, via use of the laser subtraction process and the CNC milling process, even though both are manufactured with a same injection molding tool process and derived from the same MIM blank. Additional customizations can be made with the CNC station and then use another sub process i) a hot wire, ii) stamping—cut die, a press, etc., or other mechanism to remove/shape more material from the MIM blank to eventually form a final shape and geometry of the part after sintering. At least the sub processes remove and shape material from an instance of the MIM blank of a first type of component part to form the interim shape and geometry of this instance of the first type of component part when the first instance of the part in the MIM blank form is still not in a hardened state. Note, the interim shape and geometry/not hardened state for the MIM blank is when the MIM blank of the first component part is in a very soft state compared to a final sintered state of that first component part or a final steel billet of that part, which allows significant time savings in the removal of material or insertion of an aesthetic design onto that component part.

Again, the instance of the MIM blank for the component part is made oversized to allow removal of material to the smaller finished geometry and shape after sintering so that a same injection molding process can produce multiple different versions of metal parts for multiple different wearable time keeping device can all come from the same injection molding station. With a prior MIM process, the general desired shape or net shape of a component part is determined after the injection molding process. With this MIM process 200 using at least a laser subtraction and/or a CNC sub process, the need for a custom injection mold MIM tool for every new shape on a watch design would not be needed. This greatly reduces the tooling cost and the lead time for creating a new MIM injection mold tool for new watch shapes. This provides manufacturing flexibility to create new and different instances of a type of component part, such as watch case with external aesthetics and/or geometries quickly and without the investment in a new MIM injection molding tooling. For example, using the laser subtraction to remove material while not in a hardened state can eliminate a major portion of the prior technique of forging a component part to a finished hardened state and then CNC machining to remove hardened metal.

Thus, in the case of a digital watch, the display, the watch programs, and other internal mechanical feature can remain the same for multiple different watch ID designs, where of all these platforms are using the same or similar technology. What can define a specific digital watch's technology platform is the internal PCBA module and display type. There is generally a standard PCBA module that contains the sensor, battery, buttons, crown sensor, hardware, etc. The MIM injection molding process would allow for these standard internal mechanical features to be formed with the MIM injection molding tool. The same goes for more traditional analog watch designs. However, the external geometry, shape, and aesthetics of each different watch design can significantly differ via the MIM with at least the CNC milling sub process.

With the current watch manufacturing process of forging and later CNC machining, all of these internal and external mechanical features generally have to be CNC machined or re-forged after the finished shape is hardened. Forming the majority of all these mechanical changes to a watch design with the MIM injection process with one or more sub processes on a non-hardened MIM blank greatly reduces the CNC machining times on post finished state component parts. The MIM blank as, for example, a green part is much softer than the finished component part in a post-sinter state. The prior process of forging and CNC machining of a hardened metal billet that the component part is very difficult and time-consuming. In this prior technique, the metal billet after being forged into the near net shape has to be first annealed to soften the metal back to a workable state and then worked on.

In contrast, the laser subtraction process and/or the CNC machining of material of, for example, a green-state part is much faster and easier given the softness of the green-state part compared to the steel billet. This laser subtraction process of component parts in, for example, a green state saves time, multiple post processing steps; and thus, the final cost for the finished component part, such as a case or bezel. In addition, the external aesthetic features can also be machined or imprinted in a soften state to allow for great manufacturing flexibility. For each different watch design, the MIM process 200 with sub processes can quickly change or update the external surface to create a different looking watch without making a new MIM tool or forging tool. This flexibility gives the MIM process 200 with sub processes the ability to create new shapes to differentiate the watch.

The subtractive manufacturing of an oversized Metal Injection Molding (MIM) blank is the subtractive process of removing MIM material with laser in a controlled method that forms functional and decorative geometry using a MIM Green part blank as a starting part. This base MIM Green Part can have common internal features that carry common functional features for a watch platform configuration, for example, a same display, speaker, Printed Circuit Board, etc.

This give great flexibility with creating external aesthetic geometry and functional geometry that cannot be formed with the fine detailed required during the injection molding process.

The method can use one or more lasers (high power laser, a small beam width laser, etc.) to cut, vaporize, and create geometry in parts. The laser formed geometry creates a better level of fine detail and at a much faster rate than the current CNC process. The fine level of detail can get very precise down into the nanometers as the laser will burn and vaporize the material in order to remove it from the raw product. In the process, metal powder (any metal material) and any other powder such as plastics or ceramics, can be mixed to create a compound that's going to be granulated and fed in as feedstock into an injection molding to form the rough part. Thus, the laser subtractive manufacturing of an oversized MIM blank creates a much cheaper watchcase, bezel, bracelet, etc. just on the time saving of creating the geometry features for each watch.

Also, the laser subtractive manufacturing of an oversized Metal Injection Molding (MIM) Blank removes MIM material when in the Green part state is very easy to vaporize or burn away. The laser subtractive manufacturing of an oversized MIM blank process can create very detail features without any leftover residue that could impact the later process of the MIM part to the final sinter state of being a stainless steel part. The laser subtractive manufacturing of an oversized MIM blank takes advantage of the MIM Green Part state of being part metal powder and plastic powder so the metal can be heated to vaporize away other materials. The metal powder heats and burns very easily with a laser and with enough energy to burn and remove both the plastic and metal material at the same time. The laser subtractive manufacturing of an oversized MIM blank takes advantage of the MIM Feedstock material properties that are perfect for burning and/or vaporizing away in a subtractive manufacturing process. This laser cutting process step removes material and creates functional and aesthetic geometry in the part being manufactured.

The laser removal and shaping of MIM green part (e.g. not yet hardened) with a laser cutting, burning or vaporizing process of the MIM green part material. This process allows a MIM green part to be cut and shaped very easily into many different types of watchcase, watch bezel, bracelet shapes and geometries by using a laser to cut or etch the MIM Feedstock material. This laser process can cut many different 2D profiles or 3D geometry. The laser can engrave or removed material by debossing or embossing features to create functional and aesthetic geometry in the MIM green part.

This laser process shortens the lead time that it takes to make different watches from a base MIM Blank green part. Where a new MIM injection mold tool is not needed if the external industrial design shape changes. And, this MIM material is much easily cut with a laser and reduces CNC machining times of tradition watch CNC process of cutting shapes and forms from a steel blank. The advantage is a quicker more reactive supply chain that allows a manufacturing line to satisfy a customer's demands for high volume selling watches or to quickly introduce newer models with different shapes much faster creating more diversity with our products without the add cost of creating new tools to make the new watch models or watch shapes.

Another advantage is the detail or size of the features that can formed with this laser process. The current CNC process for making watches has limitation around how small a feature can be created in harden steel. This feature size is driven mostly with CNC machining times as the features become smaller the CNC cutter has to become smaller and thus removes less material during the CNC machining process and thus adds more time. This current CNC process is always a balance of creating detail but not driving the CNC machining time and cost up. This laser process can create more intricate details without the added time and cost. There are also other size limitations that can be made with the standard CNC process. As the watch geometry features becomes smaller the CNC tool has to become smaller. The smaller the CNC tool the more prone to flexing and breaking during the manufacturing process. This laser process can reach sizes, for example, about 20%-50% smaller than the most CNC watchcase manufacturers are willing to produce in mass production.

After this laser step, the part is then processed through the normal MIM process of debinding and sintering to a fully harden steel part. The final part is created as fully hardened steel.

Inserting a laser into the manufacturing process to repeatedly create structural parts of a product being manufactured. With cutting a MIM feedstock material that is 70% metal powder and 30% plastic powder at the green parts state. This combination of materials is perfect for cutting away or removing material with a laser. Metal powder burns very easily when heated with a laser and thus is perfect for subtractive manufacturing process. Laser cutting allows for better process control and faster processing of the cutting of the MIM feedstock material in a MIM blank's green part. Previously, a MIM injection mold tool was manufactured to provide a MIM blank in a near final shape of the component. Thus, previously, most MIM parts are produced as final shapes and geometry with very limited CNC machining to remove the injection gate after sintering. However now, an oversized MIM blank can be produced from a same MIM injection mold tool, which the laser subtractive process and other processes can cut, vaporize, and otherwise form the oversized blank into a MIM part customized into the particular watch design being manufactured in that run of parts being made. The manufacturing process can create two or more metal component parts where the finished geometry and shape of a first instance of the metal component part differs from the finished shape and geometry of a second instance of the metal component part even though these component parts come from instances of the same MIM blank formed from the same injection molding tool via the subtraction process when the MIM blank was not hardened.

The laser station and/or combined CNC & laser station for the manufacturing process of a geometric structure of part actually forming the structure of a product. The laser station and/or combined CNC & laser station creates the geometry features and esthetic/decorative features for functional features on a MIM green parts with a laser subtraction process.

Again, the manufacturing process can use a number of different lasers such as a minimum of 8 watts for sufficient heat, typically around 12 watts and up to 50 watts of power to heat up the metal particles in the metal powder to vaporize that metal and remove any other material when the metal changes state and vaporizes. Note, a balance in the production/manufacturing environment power usage and an amount of time to make a part are two factors that heavily way into a selection of power for the laser. The metal is heated by the laser such that when the metal heats enough to change state from a solid to vaporizer. Note, too much heat and power could significantly affect the precision of the cuts and shapes being formed by the laser. Too much heat might spread over to adjacent areas of the material that the part actually needs to remain intact and/or deform that area including up to mini explosions. The laser can be used in conjunction with a CNC station or just by the laser itself. The CNC station just like a MIM blank can be used to make a rough cut to get the shape profile desired and then the fine detail can be burned/vaporized and created through laser reduction of material to get the geometric structures that are forming the actual structure of the product being manufactured. Note, multiple instances of the same part for this product are going to be repeatedly manufactured in this production step overtime.

The laser equipment may have better motion control systems for cutting geometry, including shapes, on MIM blanks of components that requires 3rd, 4th and 5th axis of movement. The MIM process can also have better control over laser power output level or material remove. The MIM process can create 3D shapes and geometry easier, faster, and cheaper than some previous methods. The MIM process can also create or cut 2D profile shapes or profile but the laser technology can create subtractive 3D complex geometry from a larger/oversized MIM blank in a green part state much easier and faster than the traditional CNC methodologies. Note, CNC has limitations with the types of shapes that can be created from the CNC tool and/or the speed at which the geometry is created in the MIM blank in a green part state. The current CNC process is cutting metal with metal and this is a very slow process and difficult given the force and speed at which a round metal cutting blade can remove metal to create geometry. A laser subtractive process removing material from the MIM blank in a green part state has zero mechanical force applied to the material and is using energy to cut or vaporize the material during the cutting process.

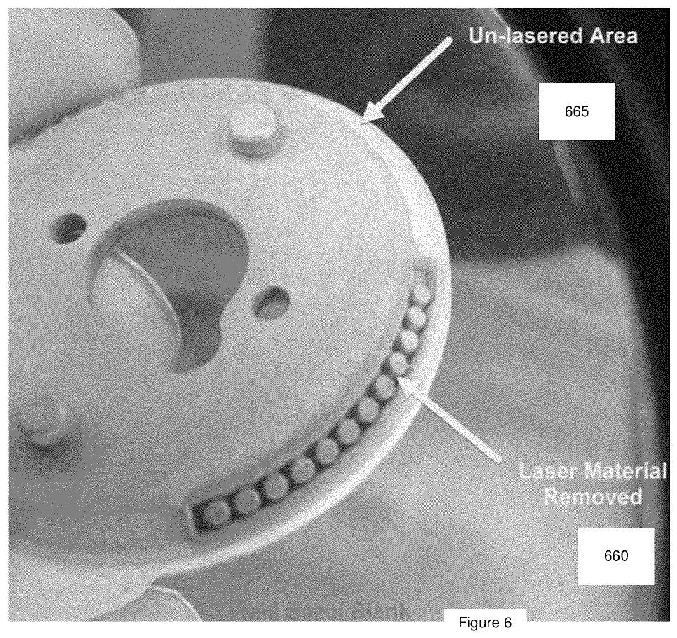

FIG. 6 illustrates a diagram of an embodiment of an example interim shape and geometry of that instance of the metal component part in its not hardened state after being shaped via at least a laser subtraction process to make shapes and geometry in small dimensions for a new feature being formed and/or 2) refining an existing feature on the MIM blank from the injection molding tool. As opposed to the CNC machine discussed above, the laser subtractive manufacturing of an oversized MIM blank is used when making the design features that form the actual geometric structures of the product; rather than just an aesthetic two dimensional engraving or ornamental design feature. The design features can get down to small dimensions such as 0.25 mm and all the way down to, for example, 100 nanometers and possibly even lower with repeatable dimensional cuts to the first instance of the manufactured part for that product itself to the last instance of the manufactured part for that product. The laser can change the focal distance for the laser to change the 3 dimensional depth of the feature being created. The laser can be used to remove material 660 from the MIM blank to create for example a series of minute cylinders forming a shape within this component. The MIM blank of the component similarly have material removed from the un-lasered area 660 to create another shape and/or geometry in that component. Thus, the height, width, and depth along with its curvature if any of the part being created will be controlled by adjusting the laser beam in three dimensions. The width of the laser beam width of the laser can control the size of the dimensions, balanced on the beam width needs to be small enough to make the dimensions of the feature being formed but must achieve the desired shape in an acceptable amount of time for the manufacturing process where every extra second decreases an overall amount of instances of that part can be created per work shift. Thus, for example, making one wide beam with lower tolerances on the resulting geometry of the part being formed can readily be better than using 6 or 7 passes with a narrow beam to form a similar geometry of the part being performed but created with more precision. Thus, control over all three of the X plane and Y plane and the Z plane for the laser beam being used can be factors in choosing a specific laser and power level and beam width to use with a specific part being manufactured from an oversized MIM blank in a yet to be hardened state. Also, the laser chosen needs to be designed to sustainably apply the laser beam at the specified wattages over and over again each day for each instance of the part being made (industrial/manufacturing use). The laser chosen depth of that dimension being cut into that manufactured part repeatedly over and over and different instances of that same part going into the manufactured products.

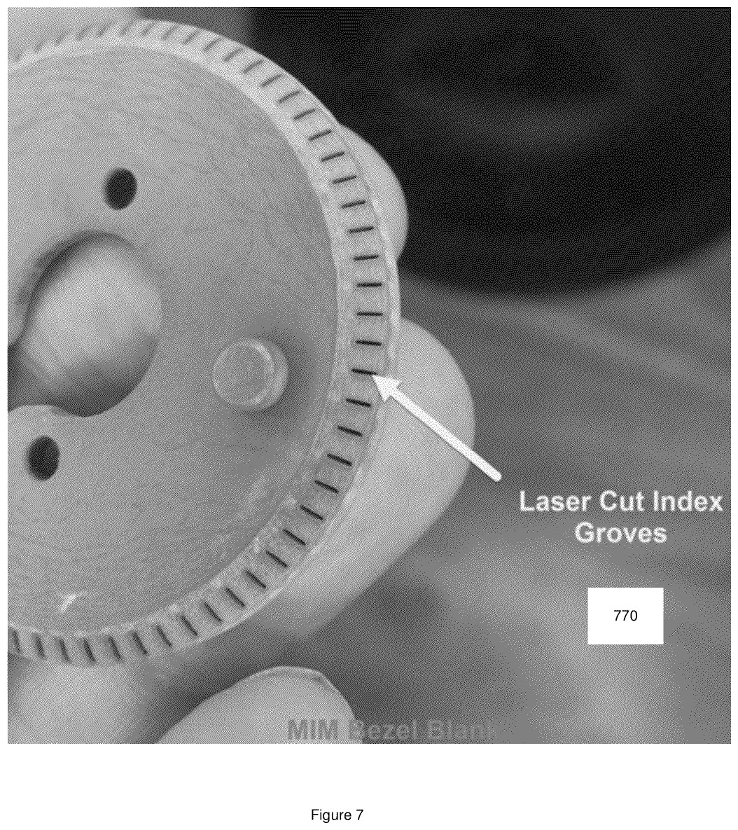

FIG. 7 illustrates a diagram of an embodiment of an example interim shape and geometry of that instance of the metal component part in its not hardened state after being shaped via at least a laser subtraction process, in which the laser can have its focal length adjusted and controlled to make 3 dimensional features in the instance of the MIM blank prior to sintering and hardening to the finished shape and geometry of the instance of the metal component part. The laser gut grooves 770 can be small in dimension and precise in shape and depth.

Many types of lasers can be used such as a gantry laser that allows you to change the focal depth, a fiber laser, a CO2 laser, etc. All of these laser stations can receive software instructions, such as a 3-D print file, fed into that laser in order to carve, through removal of material, and create repeatedly these manufactured parts.

The laser can integrate with a CNC station and this may prove very beneficial. The CNC station and its cutting tools can be used to very rapidly make a rough cut of the design features that are created with the geometric structures for actually forming the structure of that part and then use the laser for getting the fine cut and detail of a part that was already been through the CNC step. The CNC step is physically cutting away the material and so recouping that material when the raw material being removed is, for example, a precious metal, such as titanium, gold, platinum, and/or other valuable material, can be captured and recycled to form a portion of the raw material for parts in the future. After the CNC rapidly removes the majority of the precious material in a rough cut, then the laser can vaporize the very small amount of material to make the fine detail And precise cuts to form the final geometric structures forming that part. That's the rough-cut can be made with a CNC machine and the laser can then make the fine details with precise vaporizations to finish off the subtractive removal of metal and/or other material from a MIM blank in order to create the geometric structure forming the actual structure of that part.

Note, in some cases a three dimensional laser does not have to be always used. A cut in three dimensions can be made with a two dimensional laser and then moving the actual part being operated on in order to make the three dimensional incisions on the part. For example, a two dimensional laser could be used and then reposition the actual part during the process of creating that part in order to make a three dimensional cut. However, for speed and efficiency, typically a laser with a capability of changing its focal distance and the height distance when making these cuts will be used so that the part informing the geometric structure in the final part can be continuously be worked on and created. As well as, multiple instances of the part can be created in an assembly line type process. Moving tools operating on the part being created allows for continuous operations more readily than having to reposition the part for each operation.

Again, the manufacturing process can be used to make the first instance of the part being manufactured followed by the second instance and the thousand instance of the part being manufactured that day/shift.

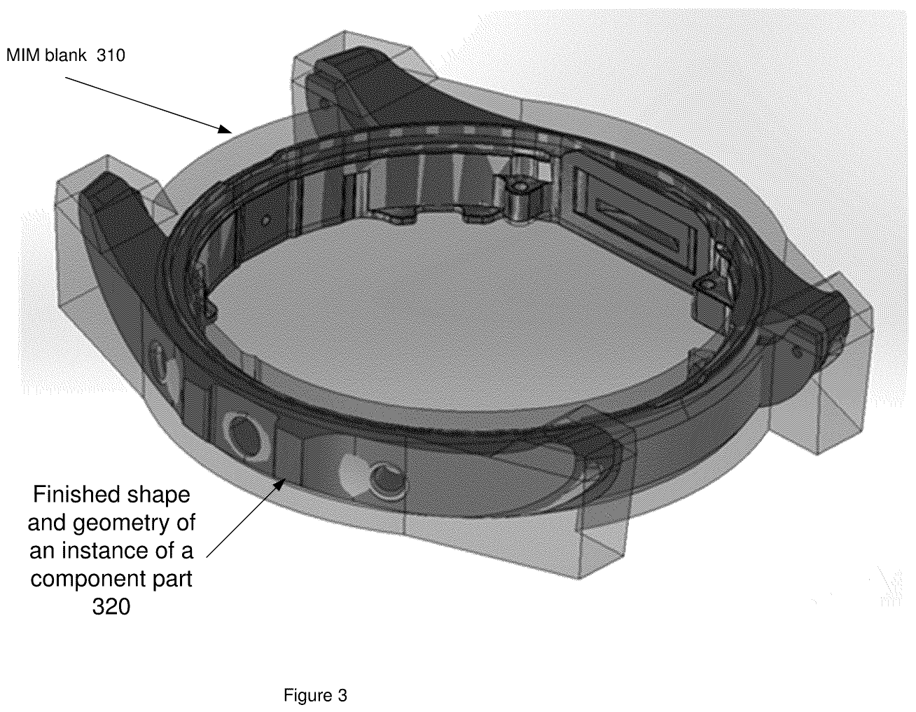

FIG. 3 illustrates a diagram of an embodiment of an example overlay of an instance of the MIM blank in a green state and not hardened from the injection molding tool that is big enough to be customized to form many different finished aesthetics, shapes, and/or geometries, via at least a laser subtraction process and/or a CNC machining process of that MIM blank, in accordance with different watch designs.

The shadowy overlay of the MIM Blank 310 as a green part from the injection molding tool is shown. The MIM Blank 310 is big enough to be customized to form many different finished aesthetics, shapes, and/or geometries, via at least some CNC machining of that component part, in accordance with different watch designs. The material removed and/or shaping of the instance of the MIM Blank 310 in green state, via sub processes, to achieve the finished aesthetic, shape, and/or geometry of metal component part 320. The finished aesthetic, shape, and/or geometry of metal component part 320 is also shown but within the overlay of the MIM blank 310.

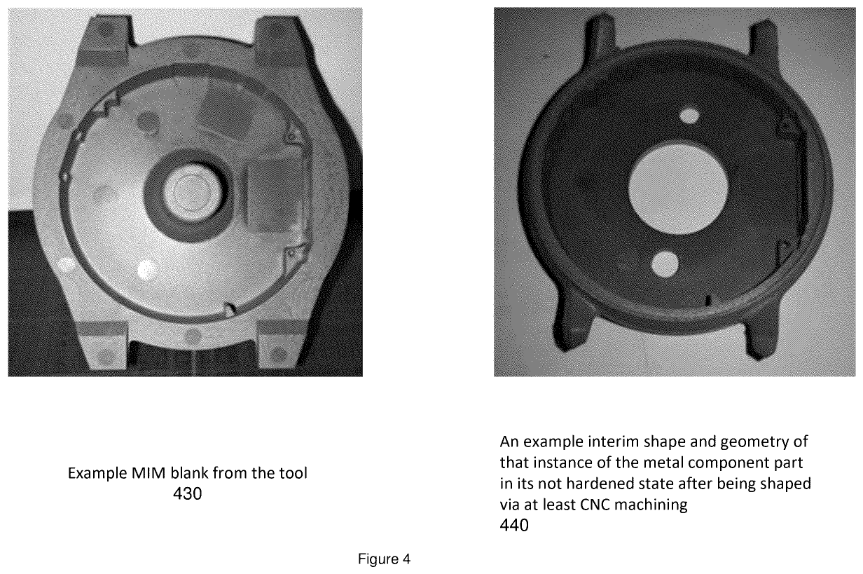

FIG. 4 illustrates a side by side comparison diagram of an embodiment an instance of an example MIM blank from the injection molding tool as well as an example interim shape and geometry of that instance of the metal component part in its not hardened state after being shaped via at least CNC machining in accordance with the specification of that watch design.

On the left side, an example instance of a MIM blank 430 for that example metal component part from the injection molding tool is shown. On the right side, an example instance of a metal component part derived from the MIM blank for that example component part in the form of an interim shape and geometry of an instance of the metal component part 440.

The MIM Blank 430 from the injection molding tool has at least the CNC milling station remove a majority of the material from the green state component before the component is hardened via sintering. Although the majority of the material is removed, some extra material must remain in the interim shape and geometry of an instance of the metal component part 440 to maintain its shape and/or make handling in process steps easier, until the component part reaches its final shape and geometry.

Thus, at least the sub process of the subtractive CNC milling process is applied to the instance of the MIM blank 430 for that type of component part when the instance of the MIM blank has not yet been sintered and hardened to a finished shape and geometry of the component part for the watch design. Multiple different finished geometries and shapes of instances of the component part can be made even though these component parts come from instances of the same MIM blank 430 formed from the same injection molding tool on a same manufacturing line.

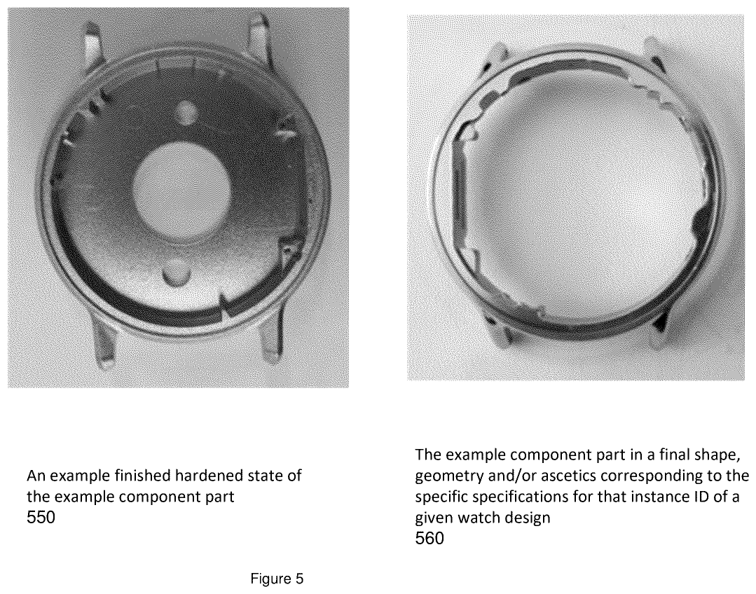

FIG. 5 illustrates a side by side comparison diagram of an embodiment an instance of an example finished hardened state of the example component part, such as a watch casing, after sintering of the component part as well as the example component part in a final shape, geometry and/or ascetics corresponding to the specific specifications for that instance ID of a given watch design.

The finished shape and geometry of the instance of the component part 550 for a watch design after sintering (shown on the left) will then go through some subsequent processing after being hardened to achieve a final hardened shape and geometry of that instance of the component part 560 (shown on the right). Again, different instances of a same MIM blank can be processed to create, for example, two casings with different finished shapes and geometries; and thus, different final shapes and geometries.

As an example, the metal component part could be a bezel being produced by the injection molding tool. A first instance of a MIM blank for bezel can be formed with the injection molding tool for a first watch design, and then the sub processes create at least a portion of a shape and geometry of an interim shape and geometry of the first bezel for the first watch design with the subtractive CNC milling process when the first instance of the MIM blank has not yet been sintered to harden a finished shape and geometry of the first bezel. Likewise, a second instance of a MIM blank for bezel can be formed with the injection molding tool for a second watch design, and then the sub processes create at least a portion of a shape and geometry of an interim shape and geometry of the second bezel for the second watch design with the subtractive laser process when the second instance of the MIM blank has not yet been sintered to harden a finished shape and geometry of the second bezel.

The MIM process sinters the shape and geometry of the first and second bezels to harden them. The manufacturing process may using subsequent processes to remove any extraneous material from the finished state and geometry of the first and second bezels, in accordance with their respective watch designs after being hardened in order to achieve a final hardened shape and geometry of that bezel. The MIM process with one or more sub process may create multiple different instances of a metal component part for multiple different watch ID designs, which can be used in creating both digital watches and analog watches.

Analog watches may contain a watch face and one or more springs and gears configured to control movement of hands on the watch face. The springs and gears are put into a watch body with the metal component parts that are created and formed by the MIM process. Analog watches can be driven be a quartz clock and battery or by a winding mechanism cooperating with a spring.

A watch time movement can be the engine of a watch that acts as the powerhouse to make the watch and its functions work. This internal mechanism inside the timepiece moves the hands on a watch face and powers any complications such as a chronograph, annual calendar or a dual time zone. Driving all of the timekeeping functions, the watch time movement is the essential component in a watch and keeping accurate time; a watch would not function without it.

There are different watch time movements that will fall into one of three categories quartz, or mechanical and automatic time movements.

On a quartz watch, the second hand has the tick-tick motion that moves once per second while mechanical watches have a smooth, sweeping seconds motion. Quartz movements are very accurate, battery powered, and require minimal maintenance aside from battery replacements. A quartz movement utilizes a battery as its primary power source. To create power in quartz watch movements, a battery sends an electrical current through a small quartz crystal, electrifying the crystal to create vibrations. These vibrations keep the movement oscillating and drive the motor to move the watch hands.

Mechanical movements contain an intricate series of tiny components working together to power the timepiece. A mechanical movement uses energy from a wound spring, rather than a battery, to power the watch. This spring stores energy and transfers it through a series of gears and springs, regulating the release of energy to power the watch. Manual-wind watches have to be manually wound by hand to create energy in the watch's mainspring. The wearer must turn the crown multiple times to wind the mainspring and store potential energy. The mainspring will unwind slowly and release energy through a series of gears and springs that regulate the release of energy. This energy is then transferred to turn the watch hands and power the watch's complications.

Another form of mechanical movements are automatic time movements. Often referred to as “self-winding”, automatic movements harness energy through the natural motion of the wearer's wrist. Kinetic energy from the wearer's wrist is transferred automatically to drive the mechanisms inside the watch. The mainspring is automatically wound from the natural movements of the wearer's wrist. An automatic movement works largely the same way that manual movements do, with the addition of a metal weight called a rotor. The rotor is connected to the movement and it can rotate freely. The rotor spins with each movement of the wrist, transferring the energy to the mainspring. The mainspring is automatically wound as a result of this energy transfer.

An example wearable time keeping digital device, such as a digital watch, may have a display, one or more processors, one or more memories sensors and other functions on a printed circuit board, one or more batteries, and metal component parts. The wearable time keeping digital device may include various components including a housing with a display screen. One or more processors are located in the housing. Various metal component parts and other parts may be assembled to form the housing. The processor is configured to process commands to present an onscreen display on the display screen to enable the wearer of the electronic device to select a number of different operations. One or more non-transitory computer readable storage mediums in the housing are accessible to the processor for storing instructions executable by the processor to generate the number of different operations on the onscreen display. A communication circuit is located in the housing. One or more rechargeable batteries are used for the wearable time keeping device. The watch may display electronic hands and/or may have mechanical hands.

Again, the wearable time keeping digital device electronic may be a smart watch or smart activity tracker. The communication circuit of the wearable time keeping digital device may use NFC communications (active and passive), Bluetooth, Zigbee, have cellular connectivity (e.g. 3G/4G/5G/), Wi-Fi, etc. to another computing device cooperating with the wearable time keeping device.

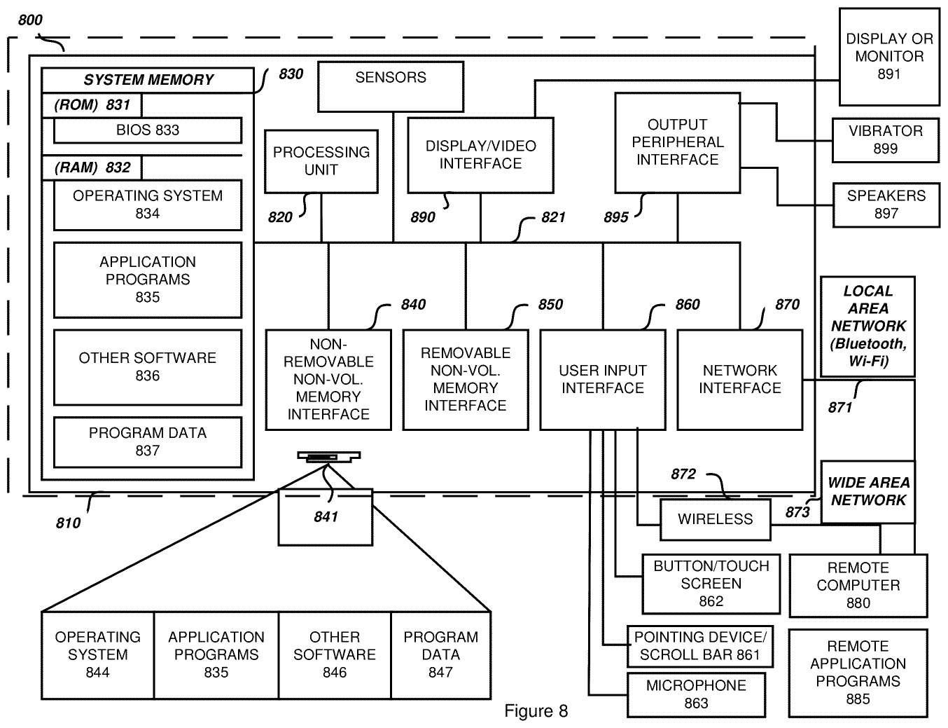

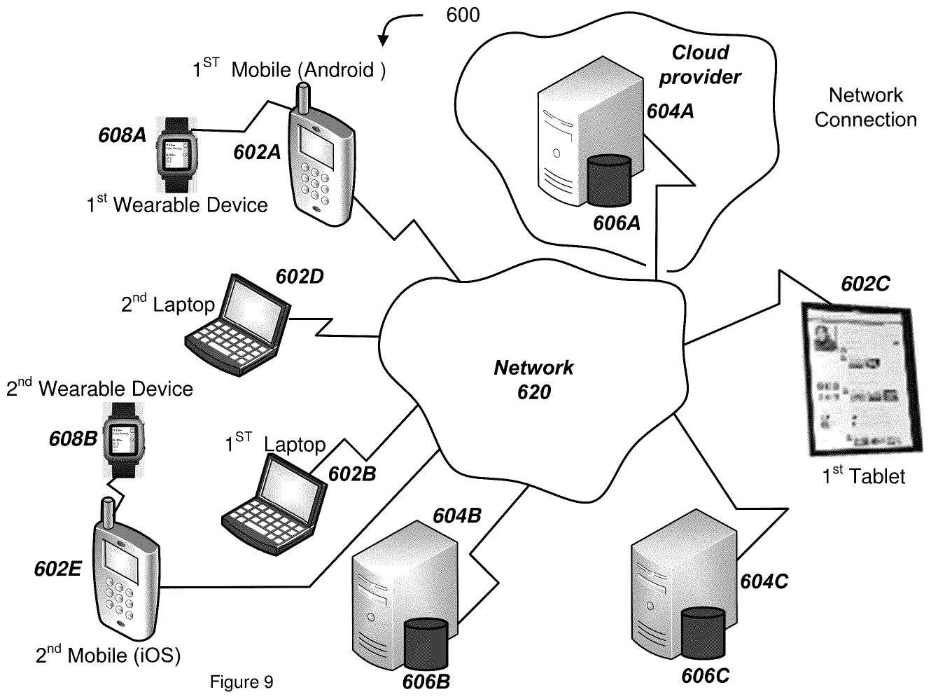

In general, the wearable time keeping device includes one or more communication and processing systems, which can be coupled externally to one or more networks. FIGS. 8-9 illustrate additional example environments to implement the concepts. The housing also has a computer readable storage medium in the housing accessible to the processor for storing instructions executable by the processor to generate the number of different operations on the onscreen display.

FIG. 8 illustrates a block diagram of an example computing system that may be used in an embodiment of one or more of the servers, wearable time keeping digital devices, and client devices discussed herein. The computing system environment 800 is only one example of a suitable computing environment, such as a client device, server, wearable time keeping device, etc., and is not intended to suggest any limitation as to the scope of use or functionality of the design of the computing system 810. Neither should the computing environment 800 be interpreted as having any dependency or requirement relating to any one or combination of components illustrated in the exemplary operating environment 800.

In an embodiment, the wearable time keeping device can connect through a wireless network to an app store having thousands of applications and watch faces that can be downloaded. The applications include notifications for emails, calls, text messages & social media activity; stock prices; activity tracking (movement, sleep, estimates of calories burned); remote controls for smartphones, cameras & home appliances; turn-by-turn directions (using the GPS receiver in a smartphone or tablet); display of RSS or JSON feeds; and also include hundreds of custom watch faces.

In an embodiment, the wearable time keeping device can originally be shipped with applications pre-installed. These applications can use data received from a connected phone for distance, speed and range information. The applications can also directly connect to a backend server on the cloud. More applications are downloadable via a mobile phone or tablet.

In an embodiment, the wearable timekeeping devices can integrates with any phone or tablet application that sends out native iOS or Android notifications.

The wearable time keeping device also has a computer readable storage medium, e.g., solid-state memory 840, in the housing accessible to the processor 820 and stores instructions executable by the processor to generate the number of different operations on the onscreen display 891.

In an embodiment, the wearable time keeping device is a wristwatch that has a watch housing in which the onscreen display bears a time indication, either digital or analog. In certain instances, the wristwatch may be a smart watch. In one embodiment, the wristwatch has one or more manipulatable physical buttons that are arranged on the housing of the watch. In other embodiments, the wristwatch may have a touch screen, scrolling device, additional buttons or a combination of some or all of these. A flexible wristband is engagable with the housing of the watch to hold the housing of the watch onto a wearer.

In an embodiment, the electronic wearable device has a bezel coupled to the display screen as well has a lithium based battery. The lithium-based battery is located in the housing. In one embodiment, the lithium-based battery has at least 130 milliampere-hour (mAh) in electrical storage capacity, and can power the electronic components in a wearable time keeping device. The lithium-based battery can also power the display screen, the communication circuit, and the processor. The display screen can be selected from the group of any of an ePaper display, a monochrome LCD display, and a color LED backlit display, and OLED display, that all consume lower battery power than some other color LCD screens. The battery contains enough capacity of at least 130 mAh to allow the display screen to stay on constantly and last up to multiple days on a single charge of the battery.

In an embodiment, the wearable time keeping device is a smart watch which features a LCD display screen, a programmable CPU, memory, storage, Bluetooth, a vibrating motor, a heart rate sensor, GPS, and an accelerometer. These features extend the smart watch's use beyond just displaying the time on the display screen and into many roles including interacting with smartphone notifications, activity tracking, gaming, map display, golf tracking, and more. The smart watch is compatible with Android and iOS devices. When connected to one of these devices via Bluetooth, the smart watch can (but may not need to) pair with that device and vibrate and display text messages, fitness information, emails, incoming calls, and notifications from social media accounts. The smart watch can also act as a remote control for the telephone function in the paired device, or for other paired devices containing a camera such as the GoPro.

Possible MIM materials that can be laser cut include 300 Series Austenitic Stainless Steel Alloys, 400 Series Martensitic Stainless Steel Alloys, Carbon Steel Alloys, Titanium Alloys, Ceramic, Tungsten Alloys, Tungsten Steel, Aluminum Alloys, Platinum Alloys, Gold, Silver, Copper, and other similar materials.

### Computing System

With reference to FIG. 8, components of the computing system 810 may include, but are not limited to, a processing unit 820 having one or more processing cores, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing system 810 typically includes a variety of computing machine-readable media. Computing machine-readable media can be any available media that can be accessed by computing system 810 and includes both volatile and nonvolatile media, removable and non-removable media. By way of example, and not limitation, computing machine-readable mediums uses include storage of information, such as computer readable instructions, data structures, other executable software or other data. Computer storage mediums include, but are not limited to, RAM, ROM, EEPROM, flash memory or other memory technology, or any other tangible medium which can be used to store the desired information and which can be accessed by computing device 800. Transitory media such as wireless channels are not included in the machine-readable media. Communication media typically embodies computer readable instructions, data structures, other executable software, or other transport mechanism and includes any information delivery media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computing system 810, such as during start-up, is typically stored in ROM 831. RAM 832 typically contains data and/or software that are immediately accessible to and/or presently being operated on by processing unit 820. By way of example, and not limitation, FIG. 8 illustrates that RAM can include a portion of the operating system 834, other executable software 836, and program data 837.

The computing system 810 may also include other removable/non-removable volatile/nonvolatile computer storage media. By way of example only, FIG. 8 illustrates a solid-state memory 841. Other removable/non-removable, volatile/nonvolatile computer storage media that can be used in the exemplary operating environment include, but are not limited to, USB drives and devices, flash memory cards, solid state RAM, solid state ROM, and the like. The solid-state memory 841 is typically connected to the system bus 821. In an example, the wearable time keeping device can have RAM which can include some space for the OS, 834 some space for the applications, and some space for the services.

As an example, the computer readable storage medium 841 stores Operating System software for smart watches to cooperate with both Android OS and iOS.

The drives and their associated computer storage media discussed above and illustrated in FIG. 8, provide storage of computer readable instructions, data structures, other executable software and other data for the computing system 810. In FIG. 8, for example, the solid state memory 841 is illustrated for storing operating system 844, other executable software 846, and program data 847. Note that these components can either be the same as or different from operating system 834, other executable software 836, and program data 837. Operating system 844, other executable software 846, and program data 847 are given different numbers here to illustrate that, at a minimum, they are different copies.

A user may enter commands and information into the computing system 810 through input devices such as a keyboard, touchscreen, or even push button input component 862, a microphone 863, a pointing device and/or scrolling input component 861, such as a mouse, trackball or touch pad. The microphone 863 may cooperate with speech recognition software. These and other input devices are often connected to the processing unit 820 through a user input interface 860 that is coupled to the system bus, but may be connected by other interface and bus structures, such as a parallel port, game port or a universal serial bus (USB). A display monitor 891 or other type of display screen device is also connected to the system bus 821 via an interface, such as a display and video interface 890. In addition to the monitor, computing devices may also include other peripheral output devices such as speakers 897 and other output device, which may be connected through an output peripheral interface 890.

The computing system 810 may operate in a networked environment using logical connections to one or more remote computers/client devices, such as a remote computing device 880. The remote computing device 880 may be a wearable time keeping device, a personal computer, a hand-held device, a server, a router, a network PC, a peer device or other common network node, and typically includes many or all of the elements described above relative to the computing system 810. The logical connections depicted in FIG. 8 include a local area network (LAN) 871 and a wide area network (WAN) 873, but may also include other networks. Such networking environments are commonplace in offices, enterprise-wide computer networks, intranets and the Internet. A browser application may be resident on the computing device and stored in the memory.

When used in a LAN networking environment, the computing system 810 is connected to the LAN 871 through a network interface or adapter 870, which can be a Bluetooth or Wi-Fi adapter. When used in a WAN networking environment, the computing system 810 typically includes a modem 872, e.g., a wireless network, or other means for establishing communications over the WAN 873, such as the Internet. The wireless modem 872, which may be internal or external, may be connected to the system bus 821 via the user-input interface 860, or other appropriate mechanism. In a networked environment, other software depicted relative to the computing system 810, or portions thereof, may be stored in the remote memory storage device. By way of example, and not limitation, FIG. 8 illustrates remote application programs 885 as residing on remote computing device 880. It will be appreciated that the network connections shown are exemplary and other means of establishing a communications link between the computing devices may be used.

As discussed, the computing system may include a processor, a memory, a built in battery to power the computing device, an AC power input to charge the battery, a display screen, a built-in Wi-Fi circuitry to wirelessly communicate with a remote computing device connected to network.

It should be noted that the present design can be carried out on a computing system such as that described with respect to FIG. 8. However, the present design can be carried out on a server, a computing device devoted to message handling, or on a distributed system in which different portions of the present design are carried out on different parts of the distributed computing system.

Another device that may be coupled to bus 811 is a power supply such as a battery and Alternating Current adapter circuit. As discussed above, the DC power supply may be a battery, a fuel cell, or similar DC power source that needs to be recharged on a periodic basis. The wireless communication module 872 may employ a Wireless Application Protocol to establish a wireless communication channel.

### Network Environment

FIG. 9 illustrates a diagram of a network environment in which the wearable time keeping device and techniques described herein may be applied. The network environment 600 has a communications network 620 that connects server computing systems 604A through 604C, and at least one or more client computing systems 602A to 602F. As shown, there may be many server computing systems 604A through 604C and many client computing systems 602A to 602F connected to each other via the network 620, which may be, for example, the Internet. Note, that alternatively the network 620 might be or include one or more of: an optical network, a cellular network, the Internet, a Local Area Network (LAN), Wide Area Network (WAN), satellite link, fiber network, cable network, or a combination of these and/or others. It is to be further appreciated that the use of the terms client computing system and server computing system is for clarity in specifying who generally initiates a communication (the client computing system) and who responds (the server computing system). No hierarchy is implied unless explicitly stated. Both functions may be in a single communicating device, in which case the client-server and server-client relationship may be viewed as peer-to-peer. Thus, if two systems such as the client computing system 602A and the server computing system 604A can both initiate and respond to communications, their communication may be viewed as peer-to-peer. Likewise, communications between the server computing systems 604A and 604-B, and the client computing systems 602A and 602C may be viewed as peer-to-peer if each such communicating device is capable of initiation and response to communication. Additionally, server computing systems 604A-604C also have circuitry and software to communication with each other across the network 620. One or more of the server computing systems 604A to 604C may be associated with a database such as, for example, the databases 606A to 606C. Each server may have one or more instances of a virtual server running on that physical server and multiple virtual instances may be implemented by the design. A firewall may be established between a client computing system 602C and the network 620 to protect data integrity on the client computing system 602C. Each server computing system 604A-604C may have one or more firewalls.

A cloud provider service can install and operate application software in the cloud and users can access the software service from the client devices. Cloud users who have a site in the cloud may not solely manage the cloud infrastructure and platform where the application runs. Thus, the servers and databases may be shared hardware where the user is given a certain amount of dedicate use of these resources. The user's cloud-based site is given a virtual amount of dedicated space and bandwidth in the cloud. Cloud applications can be different from other applications in their scalability which can be achieved by cloning tasks onto multiple virtual machines at run-time to meet changing work demand. Load balancers distribute the work over the set of virtual machines. This process is transparent to the cloud user, who sees only a single access point.

The cloud-based remote access is coded to utilize a protocol, such as Hypertext Transfer Protocol (HTTP), to engage in a request and response cycle with both a mobile device application resident on a client device as well as a web-browser application resident on the client device. The cloud-based remote access for a wearable time keeping device, can be accessed by a mobile device, a desktop, a tablet device, and other similar devices, anytime, anywhere. Thus, the cloud-based remote access to a wearable time keeping device hosted on a cloud-based provider site is coded to engage in 1) the request and response cycle from all web browser based applications, 2) SMS/twitter based request and response message exchanges, 3) the request and response cycle from a dedicated on-line server, 4) the request and response cycle directly between a native mobile application resident on a client device and the cloud-based remote access to a wearable time keeping device, and 5) combinations of these.

In an embodiment, the server computing system 604A may include a server engine, a web page management component, a content management component, and a database management component. The server engine performs basic processing and operating system level tasks. The web page management component handles creation and display or routing of web pages or screens associated with receiving and providing digital content and digital advertisements. Users may access the server-computing device by means of a URL associated therewith. The content management component handles most of the functions in the embodiments described herein. The database management component includes storage and retrieval tasks with respect to the database, queries to the database, and storage of data.

An embodiment of a server computing system to display information, such as a web page, etc. is discussed. An application including any program modules, when executed on the server computing system 604A, causes the server computing system 604A to display windows and user interface screens on a portion of a media space, such as a web page. A user via a browser from the client computing system 602A may interact with the web page, and then supply input to the query/fields and/or service presented by a user interface of the application. The web page may be served by a web server computing system 604A on any Hypertext Markup Language (HTML) or Wireless Access Protocol (WAP) enabled client computing system 602A or any equivalent thereof. For example, the client mobile computing system 602A may be a wearable time keeping device, smart phone, a touch pad, a laptop, a netbook, etc. The client computing system 602A may host a browser to interact with the server computing system 604A. Each application has a code scripted to perform the functions that the software component is coded to carry out such as presenting fields and icons to take details of desired information. Algorithms, routines, and engines within the server computing system 604A take the information from the presenting fields and icons and put that information into an appropriate storage medium such as a database. A comparison wizard is scripted to refer to a database and make use of such data. The applications may be hosted on the server computing system 604A and served to the browser of the client computing system 602A or directly to an app running on the client computing system 602A. The applications then serve pages that allow entry of details and further pages that allow entry of more details.

### Scripted Code

Any application and other scripted code components may be stored on a non-transitory computing machine-readable medium which, when executed on the machine causes the machine to perform those functions. The applications including program modules may be implemented as logical sequences of software code, hardware logic circuits, and any combination of the two, and portions of the application scripted in software code are stored in a non-transitory computing device readable medium in an executable format. In an embodiment, the hardware logic consists of electronic circuits that follow the rules of Boolean Logic, software that contain patterns of instructions, or any combination of both.

The design is also described in the general context of computing device executable instructions, such as applications etc. being executed by a computing device. Generally, programs include routines, objects, widgets, plug-ins, and other similar structures that perform particular tasks or implement particular abstract data types. Those skilled in the art can implement the description and/or figures herein as computer-executable instructions, which can be embodied on any form of computing machine-readable media discussed herein.

Some portions of the detailed descriptions herein are presented in terms of algorithms/routines and symbolic representations of operations on data bits within a computer memory. These algorithmic descriptions and representations are the means used by those skilled in the data processing arts to most effectively convey the substance of their work to others skilled in the art. An algorithm/routine is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms/routine of the application including the program modules may be written in a number of different software programming languages such as C, C++, Java, HTML, or other similar languages.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computing system, or similar electronic computing device, that manipulates and transforms data represented as physical (electronic) quantities within the computing system's registers and memories into other data similarly represented as physical quantities within the computing system memories or registers, or other such information storage, transmission or display devices.

Although embodiments of this design have been fully described with reference to the accompanying drawings, it is to be noted that various changes and modifications will become apparent to those skilled in the art. Such changes and modifications are to be understood as being included within the scope of embodiments of this design as defined by the appended claims. For example, the device may include a barometer inside the housing of the device that also makes use of the microphone sealing component with one or more channels with the water resistant material for reasons of mechanical robustness as well as the pressure equalization benefit. Alternatively, the device may act as a barometer with the microphone seal with one or more channels to allow the sensed pressure internally in the device, the device uses this internal pressure to detect current depth of the device by the pressure. The invention is to be understood as not limited by the specific embodiments described herein, but only by scope of the appended claims.

1. A method of making metal component parts for a watch, including one or more of types of metal component parts selected from a group consisting of i) a casing, ii) a bezel, iii) a buckle, iv) parts for a watch band, and v) any combination of these, with a Metal Injection Molding (MIM) process, comprising:
making a first type of metal component part for a watch design that can be derived from an instance of a MIM blank for the first type of metal component part formed from an injection molding tool, in which the instance of the MIM blank formed for the first type of metal component part from the injection molding tool then has at least a portion of the instance of the MIM blank subtracted through a laser subtraction process to form an interim shape and geometry of the instance of the first type of metal component part for a watch design; and
where the laser subtraction process is applied to the instance of the MIM blank for the first type of metal component part when the instance of the MIM blank has not yet been sintered and hardened to a finished shape and geometry of a final instance of the first type of metal component part for the watch design.

2. The method of making metal component parts for the watch of claim 1, further comprising:
forming the interim shape and geometry of the instance of the first type of metal component part for the watch design with a combination of the laser subtraction process and a subtractive CNC milling process on the instance of the MIM blank to remove MIM material from the MIM blank prior to sintering and hardening to the finished shape and geometry of the instance of the first type of metal component part for the watch design.

3. The method of making metal component parts for the watch of claim 1, where the first type of metal component part is the casing, and a first casing and a second casing from an identical MIM blank have different finished shapes and geometries after being modified during the laser subtraction process and then sintered and hardened to their finished shape and geometry, and
where the laser subtraction process removes MIM material with a laser in a controlled method to form at least one of functional geometry and decorative geometry on the MIM blank from the injection molding tool.

4. The method of making metal component parts for the watch of claim 1, further comprising:
where the first type of metal component part is the bezel, forming a first instance of the bezel with a same injection molding tool for a first watch design from a first instance of the MIM blank with the MIM process, and then creating at least a portion of a first interim shape and geometry of the first bezel for the first watch design with the subtractive laser process when the first instance of the MIM blank has not yet been sintered to harden a finished shape and geometry of the first bezel in order to create a first instance of the bezel with a first distinctive shape and geometry,
forming a second instance of the bezel with the same injection molding tool for a second watch design from a second instance of the MIM blank with the MIM process, and then creating at least a portion of a second interim shape and geometry of the second bezel for the second watch design with the subtractive laser process when the second instance of the MIM blank has not yet been sintered to harden a finished shape and geometry of the second instance of the bezel in order to create a second instance of the bezel with a second distinctive shape and geometry that is distinctive from the first distinctive shape and geometry, and
sintering the shape and geometry of the second instance of the bezel for the second watch design to achieve hardened metal in the finished shape and geometry of the second instance of the bezel for the second watch design.

5. The method of making metal component parts for the watch of claim 1, further comprising:
controlling a width of a laser beam of the laser in the laser subtraction process so as to be small enough in width to make shapes and geometry in dimensions between 2 millimeters and 100 nanometers to make dimensions of at least one of 1) a new feature being formed and 2) refining an existing feature on the MIM blank from the injection molding tool.

6. The method of making metal component parts for the watch of claim 1, further comprising:
using both i) a laser from the laser subtractive process in addition to ii) one or more cutting tools from a subtractive CNC milling process to form the interim shape and geometry of the MIM blank when the MIM blank has not yet been sintered, where the cutting tools of a CNC station and a laser beam of the laser cooperate to make a series of rough and precise cuts to form a geometric structure on the MIM blank from the injection molding tool.

7. The method of making metal component parts for the watch of claim 1, further comprising:
using the laser subtraction process applied to the instance of the MIM blank for the first type of component part, and
controlling all three of an X plane and a Y plane and a Z plane for a laser beam from the laser to make 3 dimensional features in the instance of the MIM blank prior to sintering and hardening to the finished shape and geometry of the instance of the first type of metal component part for the watch design.

8. The method of making metal component parts for the watch of claim 7, further comprising:
forming multiple instances of the MIM blank for the first type of metal component part with an injection molding step with a same injection molding tool, where at least two different versions of the first type of metal component parts for the watch are formed for two or more different watch designs that fit within the constraints of a size and shape of the multiple instances of identical MIM blanks coming out of the same injection molding tool, where the different versions of the first type of metal component parts for the watch are formed via using at least the laser subtraction process to achieve two or more different finished shapes and geometries for that metal component part.

9-20. (canceled)

21. The method of making metal component parts for the watch of claim 1, further comprising:
forming the first type of metal component part corresponds to the casing and wherein both the casing and a second casing are formed with an identical MIM blank and feature different finished shapes and geometries after being modified during the laser subtraction process and then sintered and hardened to the finished shape and geometry.

22. The method of making metal component parts for the watch of claim 1, further comprising:
forming a first instance of the bezel with the injection molding tool for a first watch design from a first instance of the MIM blank with the MIM process, and at least a portion of a first interim shape and geometry of the first bezel is created for a first watch design with the subtractive laser process when the first instance of the MIM blank has not yet been sintered to harden a finished shape and geometry of the first bezel in order to create the first instance of the bezel with a first shape and geometry,
forming a second instance of the bezel the injection molding tool for a second watch design from a second instance of the MIM blank with the MIM process, and at least a portion of a second interim shape and geometry of the second bezel is created for a second watch design with the subtractive laser process when the second instance of the MIM blank has not yet been sintered to harden a finished shape and geometry of the second bezel in order to create the second instance of the MIM blank having with a second shape and geometry that is distinctive from the first shape and geometry, and
forming the second instance of the bezel for the second watch design by at least sintering the shape and geometry of the second instance of the bezel to achieve hardened metal in the finished shape and geometry of the second instance of the bezel for the second watch design.

23. The method of making metal component parts for the watch of claim 1, further comprising:
using the injection molding tool for making instances of a MIM blank for creating the first type of metal component part for a wearable time keeping device;
using one or more sub process stations at least including a laser station, to make the metal component part for a wearable time keeping device;
where an instance of the metal component part corresponding to one of the types of metal component parts is made from the instance of the MIM blank for that metal component part formed from the injection molding tool, where the instance of the MIM blank for that metal component part has had at least a portion of the instance of the MIM blank subtracted through the laser subtraction process at the laser station to form an interim shape and geometry of the metal component part when not in a hardened state, and then the instance of the MIM blank for that metal component part went through a sintering process at a sinter station to then harden the metal component part to the finished shape and geometry of the final instance of the first type of metal component part for the watch design, and
where a size and shape of the instance of the MIM blank is formed such that the metal component part is derivable from the instance of the MIM blank using at least, the sub process of the laser process, to achieve two different finished shapes and geometries of the metal component part in accordance with specifications of two or more different wearable time keeping device designs, where the finished geometry and shape of a first instance of the first type of metal component part differs from a finished shape and geometry of a second instance of the first type of metal component part even though these metal component parts come from instances of identical MIM blanks formed from a same injection molding tool.

24. The method of making metal component parts for the watch of claim 23, further comprising:
where the laser subtraction and a CNC milling from a CNC milling station are applied to remove MIM material from a first instance of the MIM blank for a first metal type of component part when a first instance of the MIM blank has not yet been sintered and hardened to the finished shape and geometry of the final instance of the first type of metal component part for the watch design.

25. The method of making metal component parts for the watch of claim 23, further comprising:
where the laser station includes a laser which can be adjusted and controlled in all three of an X plane and a Y plane and a Z plane for a laser beam from the laser to make 3 dimensional features in the instance of the MIM blank prior to sintering and hardening to the finished shape and geometry of the instance of the first type of metal component part for the watch design.

26. The method of making metal component parts for the watch of claim 23, further comprising:
where the laser station includes a laser which can have its focal length adjusted and controlled to make 3 dimensional features in the instance of the MIM blank prior to sintering and hardening to the finished shape and geometry of the instance of the first type of metal component part for the watch design, and
where the one or more sub process stations include one or more stations to add a watch face, as well as one or more springs and gears configured to control movement of hands on the watch face, where the springs and gears are put into a watch with the metal component parts that are created and formed by the MIM process.

27. The method of making metal component parts for the watch of claim 1, further comprising:
where the metal component part for a watch design is made from an instance of a MIM blank for the component part formed from the injection molding tool, in which the instance of the MIM blank formed for the metal component part from the injection molding tool had the laser subtraction process applied to the metal component part, where at least a portion of the instance of the MIM blank was subtracted through the laser subtraction process to form an interim shape and geometry of the instance of the metal component part for the watch design, and
where the laser subtraction process is applied to remove MIM material from the instance of the MIM blank for the metal component part when the instance of the MIM blank has not yet been sintered and hardened to the finished shape and geometry of the final instance of the first type of metal component part for the watch design.

28. The method of making metal component parts for the watch of claim 1, where the first type of metal component part is the casing.

29. The method of making metal component parts for the watch of claim 1, where the first type of metal component part is the bezel.

30. The method of making metal component parts for the watch of claim 1, where the first type of metal component part is the buckle.
